(19) United States
(12) Patent Application Publication
(10) Pub. No.: US 2012/0149528 A1
(43) Pub. Date: Jun. 14, 2012

(54) Automatic Transmission

(75) Inventor: Donald E. Hoffman, Canton, MI (US)

(73) Assignee: FORD GLOBAL TECHNOLOGIES, LLC, Dearborn, MI (US)

(21) Appl. No.: 12/963,668

(22) Filed: Dec. 9, 2010

(51) Int. Cl. F16H 3/44; F16H 57/10

(52) U.S. Cl. 475/284; 475/271

(57) ABSTRACT

A transmission includes an input and an output, a first power path including first and second clutches, a second power path including a third clutch, a third power path including a fourth clutch, a planetary gear unit including first, second, third and fourth members, the first clutch coupling the first member to the input through the first power path, the second member secured to the output, the second clutch coupling the fourth member to the input through the first power path, the third clutch coupling the fourth member to the input through the second power path, the fourth clutch coupling the third member to the input through the third power path, a first brake for holding the third member against rotation, and a second brake for holding the fourth member against rotation.

### BACKGROUND OF THE INVENTION

1. Field of the Invention

This invention relates generally to automatic transmissions of the type that includes planetary gearsets controlled by friction clutches and brakes.

2. Description of the Prior Art

An automatic transaxle includes a planetary gearset on the input shaft aligned with the engine crankshaft centerline; a transfer gearset between the input and a second or idler shaft; a second transfer gearset, which transmits power to a third shaft or output shaft; and a final drive speed reduction gearset.

A six-speed automatic transaxle of this type conventionally includes three planetary gear units and five control elements, i.e., clutch and brakes, whose state of engagement and disengagement determines the operating gear of the transaxle, on the input shaft.

A four forward gear-single reverse gear transmission with three input clutches and two grounding brakes can be converted to a six forward gear-single reverse gear transmission by using a gearset system to provide two input speeds into the planetary and connecting two of the input clutches to a low-speed input and the third input clutch to a high speed input. An additional clutch provides a seven forward gear-single reverse gear transmission or an eight forward gear-two reverse gear transmission.

A need exits in the industry for a transmission or transaxle having only two planet gear units, instead of the conventional three planet gearsets, that are able to produce seven or eight forward speeds and low and high speed reverse drive with a minimum number of control elements.

### SUMMARY OF THE INVENTION

A transmission includes an input and an output, a first power path including first and second clutches, a second power path including a third clutch, a third power path including a fourth clutch, a planetary gear unit including first, second, third and fourth members, the first clutch coupling the first member to the input through the first power path, the second member secured to the output, the second clutch coupling the fourth member to the input through the first power path, the third clutch coupling the fourth member to the input through the second power path, the fourth clutch coupling the third member to the input through the third power path, a first brake for holding the third member against rotation, and a second brake for holding the fourth member against rotation.

The transmission includes a double planetary system on the second shaft and transfer gearsets between the input and second shaft, providing multiple speed inputs to the double planet planetary gearset. As a result, the gear mesh efficiency losses that arise from using a planet set to provide high and low speeds are eliminated.

By locating the planetary system on the second shaft, the planetary system includes only a double planetary gear unit, instead of the conventional three planetary gearsets used in current six-speed transaxles.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

FIG. 1 is a schematic diagram of a kinematic arrangement of an automatic transaxle having a first type of double planetary gear unit;

FIG. 2 is a schematic diagram of an alternate kinematic arrangement of the transaxle of FIG. 1;

FIG. 3 is a table that shows the state of control elements that control the transaxle of FIG. 1;

FIG. 4 shows a preferred number of gear teeth of the transfer gearsets;

FIG. 5 shows a preferred number of gear teeth of the planetary gear unit of FIGS. 1 and 2;

FIG. 6 is a schematic diagram of a kinematic arrangement of an automatic transaxle having a second type of double planetary gear unit;

FIG. 7 is a schematic diagram of an alternate kinematic arrangement of the transaxle of FIG. 6;

FIG. 8 shows a preferred number of gear teeth of the double planetary gear unit of FIGS. 6 and 7;

FIG. 9 is a schematic diagram of a kinematic arrangement of an automatic transaxle having a third type of double planetary gear unit;

FIG. 10 is a schematic diagram of an alternate kinematic arrangement of the transaxle of FIG. 9; and

FIG. 11 shows a preferred number of gear teeth of the double planetary gear unit of FIGS. 9 and 10.

### DESCRIPTION OF THE PREFERRED EMBODIMENT

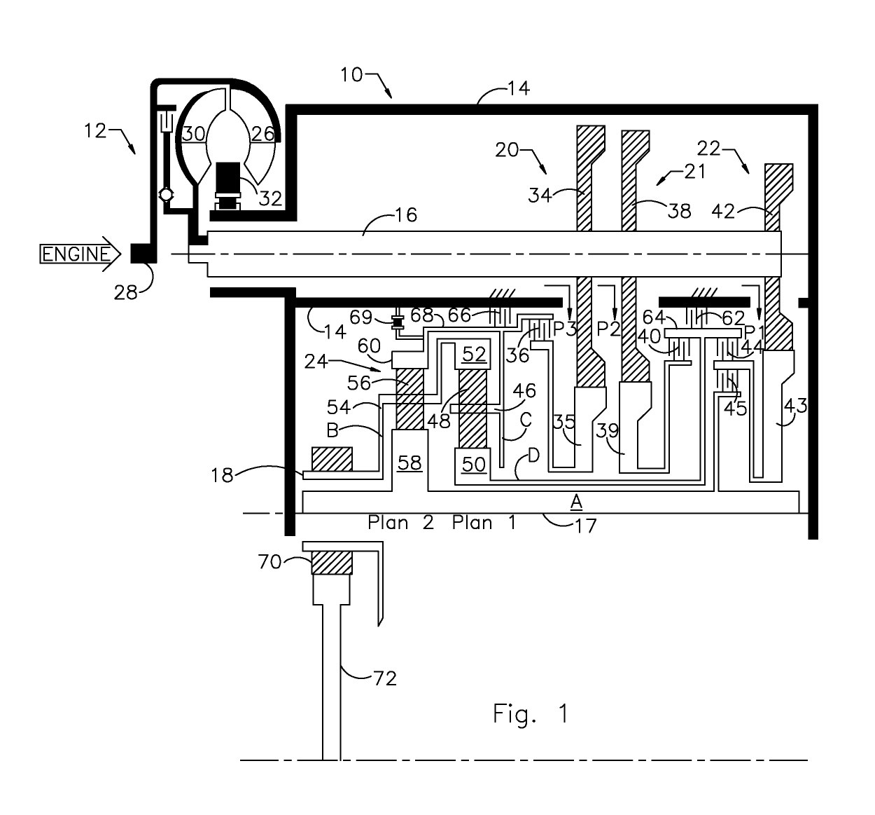

The transmission 10 shown in FIG. 1 includes a torque converter 12, casing 14, input shaft 16, second shaft 17, output shaft 18, high-speed transfer gearsets 20, 21, low-speed transfer gearset 22, and a double planetary gear unit 24, specifically a crossed ring-carrier gearset. The torque converter 12 includes an impeller wheel 26 connected to the crankshaft 28 of a power source, such as an internal combustion engine; a turbine wheel 30, and a stator wheel 32. The torque converter's impeller 26, turbine 30 and stator 32 define a toroidal fluid flow circuit, whereby the turbine is hydrokinetically driven by the impeller.

High-speed gearset 20 includes an input pinion 34 fixed to input shaft 16, and an output gear 35 meshing with the pinion and connected to control clutch 36. Gearset 20 forms a third path P3 having a high-speed ratio.

High-speed gearset 21 includes an input pinion 38 fixed to input shaft 16, and an output gear 39 connected to a control clutch 40. Gearset 21 forms a second power path P2 having a speed ratio approximately the same as the first speed ratio, preferably slightly lower in magnitude although it could be slightly higher.

Low-speed gearset 22 includes an input pinion 42 fixed to input shaft 16, and an output gear 43 connected to a control clutches 44, 45. Gearset 22 forms a first power path P1 having a speed ratio lower in magnitude than either the second or third speed ratios. Each of the first, second, and third speed ratios are negative in the current embodiment.

Gear unit 24 includes a planet carrier 46 carrying planet pinions 48 meshing with a sun gear 50 and a ring gear 52, a second planet carrier 54 carrying second planet pinions 56 meshing with a second sun gear 58 and a second ring gear 60.

A first brake 62 alternately holds a component 64, common to clutches 40, 44, against rotation on casing 14 and releases component 64. A second brake 66 alternately holds carrier 46, ring gear 60 and a component 68 of clutch 36 against rotation on casing 14 and releases those components. As shown in FIGS. 1, 6 and 9, a one-way brake 69 is arranged in parallel with brake 66 between casing 14 and member 68. This one-way brake 69 holds the first gear reaction torque when driving in first gear, instead of relying on hydraulically actuated brake 66 to hold the first gear reaction torque.

Gear unit 24 includes a first rotating member A comprising sun gear 58; a second rotating member B comprising the planet carrier 54 fixed to the ring gear 52; a third rotating member C comprising planet carrier 46 fixed to ring gear 60; and a fourth rotating member D comprising the sun gear 50. The first member A is associated with clutch 45; the second member B is secured to output shaft 18; the third member C is associated with clutch 36 and brake 66; and the fourth member D is associated with clutches 40, 44 and with brake 62.

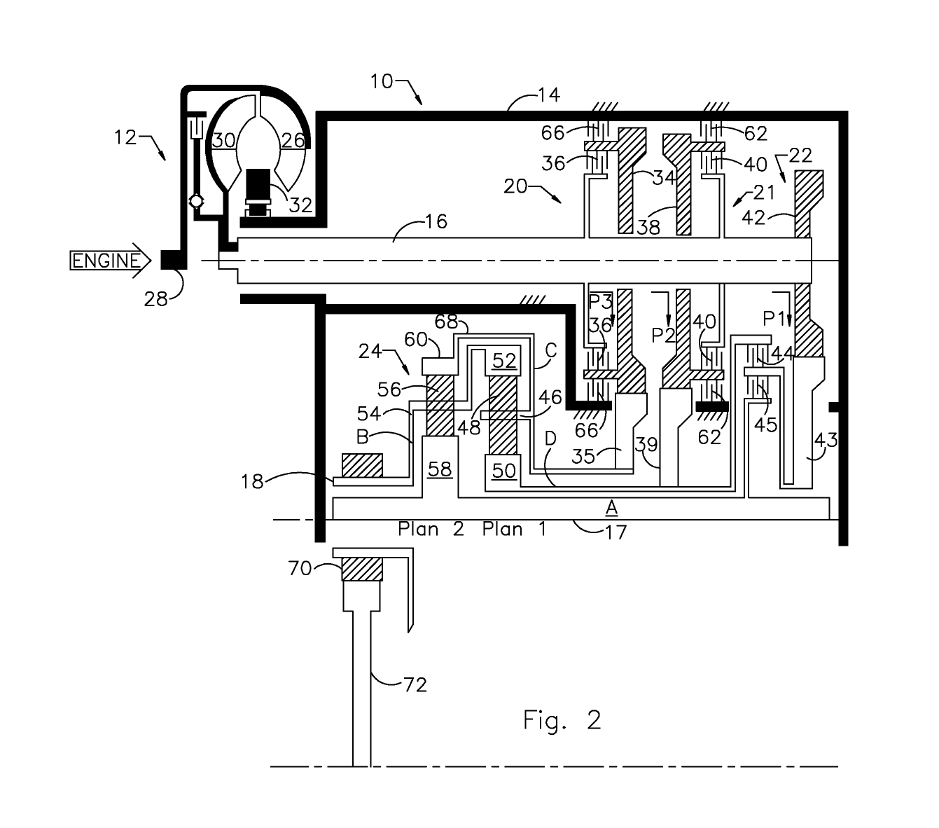

FIG. 2 illustrates transmission 10 configured such that brakes 62, 66 and clutches 36, 40 are concentric with input shaft 16, and pinions 34 and 38 are journalled on the input shaft 16, gear 35 is connected to carrier 46 and ring gear 60, and gear 39 is connected to sun gear 50.

In an alternate configuration (not shown) from that of FIG. 1 transmission 10 is configured such that brake 66 is concentric with shaft 17, as shown in FIG. 1, clutch 36 is concentric with input shaft 16, as shown in FIG. 2; pinion 34 is journalled on the input shaft 16; and gear 35 is driveably connected to carrier 46 and ring gear 60.

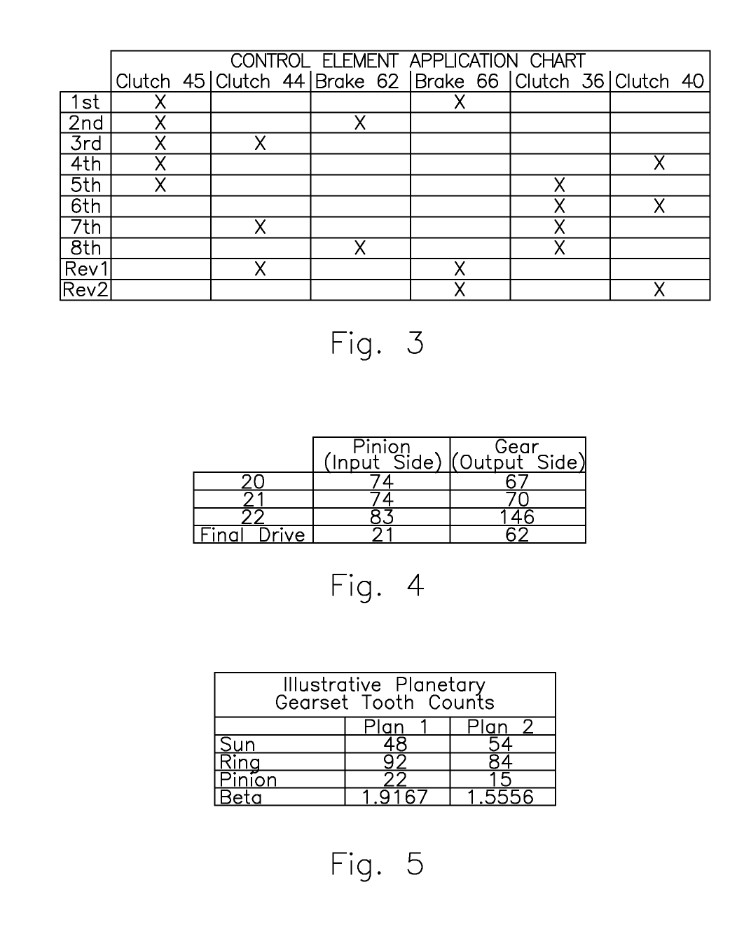

Operation of transmission 10 is described with reference to the control element application chart of FIG. 3. A first forward gear is produced when clutch 45 and brake 66 are engaged concurrently. Gear 43 rotates slower than and in the opposite direction of input shaft 16, and clutch 45 connects sun gear 58 to the input shaft 16 through gearset 22. Brake 66 provides a torsional reaction at gear unit 24, holding ring gear 60 fixed against rotation. With ring gear 60 held, gear unit 24 produces a speed reduction. The speed of output 18, carrier 54, ring gear 52 and final drive pinion 70 is −0.2225, and the speed of final drive gear 72 is 0.0753 when the speed of input 16 is 1.00 and the pinions and gears have the preferred number of teeth shown in FIGS. 4 and 5.

A second forward gear is produced when clutch 45 and brake 62 are engaged concurrently. Brake 62 holds sun gear 50 fixed. The speed of output 18, carrier 54, ring gear 52 and final drive pinion 70 is −0.3708, and the speed of final drive gear 72 is 0.1256 when the speed of input 16 is 1.00 and the pinions and gears have the preferred number of teeth shown in FIGS. 4 and 5.

A third forward gear is produced when clutch 45 and clutch 44 are engaged concurrently, thereby driving sun gears 50, 58 at the same speed. The speed of output 18, carrier 54, ring gear 52 and final drive pinion 70 is −0.5685, and the speed of final drive gear 72 is 0.1926 when the speed of input 16 is 1.00 and the pinions and gears have the preferred number of teeth shown in FIGS. 4 and 5.

A fourth forward gear is produced when clutches 45, 40 are engaged concurrently. The speed of output 18, carrier 54, ring gear 52 and final drive pinion 70 is −0.7385, and the speed of final drive gear 72 is 0.2501 when the speed of input 16 is 1.00 and the pinions and gears have the preferred number of teeth shown in FIGS. 4 and 5.

A fifth forward gear is produced when clutches 45, 36 are engaged concurrently. The speed of output 18, carrier 54, ring gear 52 and final drive pinion 70 is −0.8947, and the speed of final drive gear 72 is 0.3031 when the speed of input 16 is 1.00 and the pinions and gears have the preferred number of teeth shown in FIGS. 4 and 5.

A sixth forward gear is produced when clutches 40, 36 are engaged concurrently. The speed of output 18, carrier 54, ring gear 52 and final drive pinion 70 is −1.1292, and the speed of final drive gear 72 is 0.3825 when the speed of input 16 is 1.00 and the pinions and gears have the preferred number of teeth shown in FIGS. 4 and 5.

A seventh forward gear is produced when clutches 44, 36 are engaged concurrently. The speed of output 18, carrier 54, ring gear 52 and final drive pinion 70 is −1.3841, and the speed of final drive gear 72 is 0.4688 when the speed of input 16 is 1.00 and the pinions and gears have the preferred number of teeth shown in FIGS. 4 and 5.

An eighth forward gear is produced when clutch 36 and brake 62 are engaged concurrently. The speed of output 18, carrier 54, ring gear 52 and final drive pinion 70 is −1.6807, and the speed of final drive gear 72 is 0.5693 when the speed of input 16 is 1.00 and the pinions and gears have the preferred number of teeth shown in FIGS. 4 and 5.

A low-speed reverse drive is produced when clutch 44 and brake 66 are engaged concurrently. The speed of output 18, carrier 54, ring gear 52 and final drive pinion 70 is 0.2966, and the speed of final drive gear 72 is −0.1005 when the speed of input 16 is 1.00 and the pinions and gears have the preferred number of teeth shown in FIGS. 4 and 5.

A high-speed reverse drive is produced when clutch 40 and brake 66 are engaged concurrently. The speed of output 18, carrier 54, ring gear 52 and final drive pinion 70 is 0.5516, and the speed of final drive gear 72 is −0.1868 when the speed of input 16 is 1.00 and the pinions and gears have the preferred number of teeth shown in FIGS. 4 and 5.

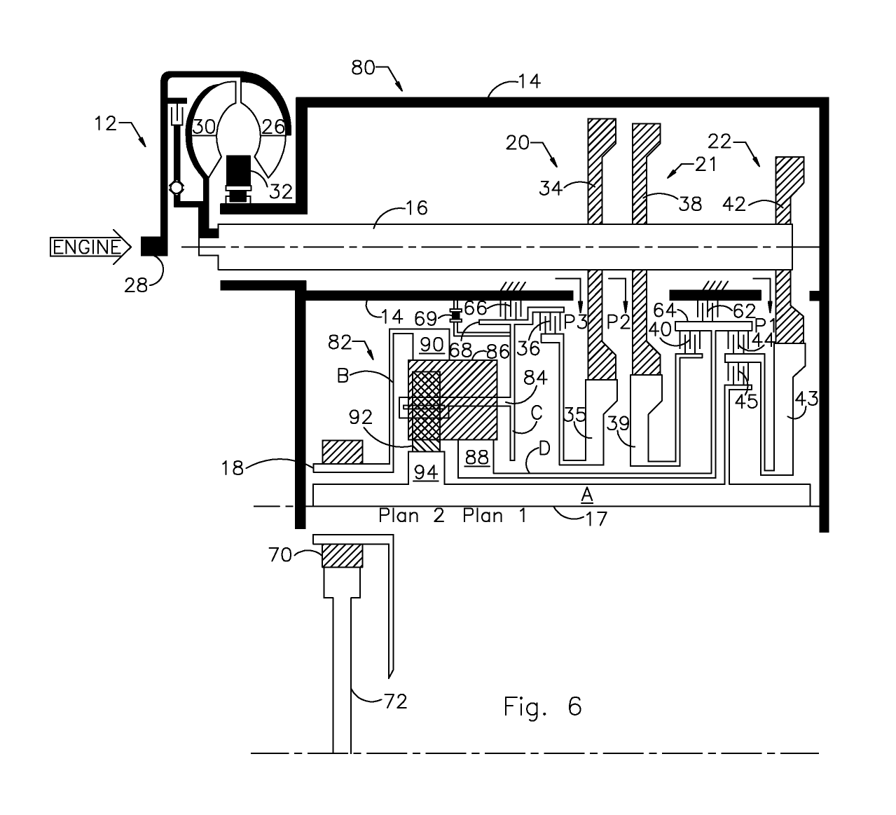

In FIG. 6, the transmission 80 includes the torque converter 12, casing 14, input shaft 16, second shaft 17, output shaft 18, high-speed transfer gearsets 20, 21, low-speed transfer gearset 22, and a double planetary gear unit 82, specifically a Ravigneaux gear unit.

High-speed gearset 20 includes an input pinion 34 fixed to input shaft 16, and an output gear 35 meshing with the pinion and connected to control clutch 36. Gearset 20 forms a third path P3 having a high-speed ratio. High-speed gearset 21 includes an input pinion 38 fixed to input shaft 16, and an output gear 39 connected to a control clutch 40. Gearset 21 forms a second power path P2 having a speed ratio approximately the same as the first speed ratio, preferably slightly lower in magnitude although it could be slightly higher.

Low-speed gearset 22 includes an input pinion 42 fixed to input shaft 16, and an output gear 43 connected to a control clutches 44, 45. Gearset 22 forms a first power path P1 having a speed ratio lower in magnitude than either the second or third speed ratios. Each of the first, second, and third speed ratios are negative in the current embodiment.

Gear unit 82 includes a planet carrier 84 supporting long planet pinions 86, meshing with a sun gear 88 and a ring gear 90; second planet pinions 92 supported on carrier 84 and meshing with a second sun gear 94 and planet pinions 86.

A first brake 62 alternately holds a component 64, common to clutches 40, 44, against rotation on casing 14 and releases component 64. A second brake 66 alternately holds carrier 84 and a component 68 of clutch 36 against rotation on casing 14 and releases those components.

Gear unit 82 includes a first rotating member A comprising sun gear 94; a second rotating member B comprising ring gear 90; a third rotating member C comprising planet carrier 84; and a fourth rotating member D comprising sun gear 88. The first member A is associated with clutch 45; the second member B is secured to output shaft 18; the third member C is associated with clutch 36 and brake 66; and the fourth member D is associated with clutches 40, 44 and with brake 62.

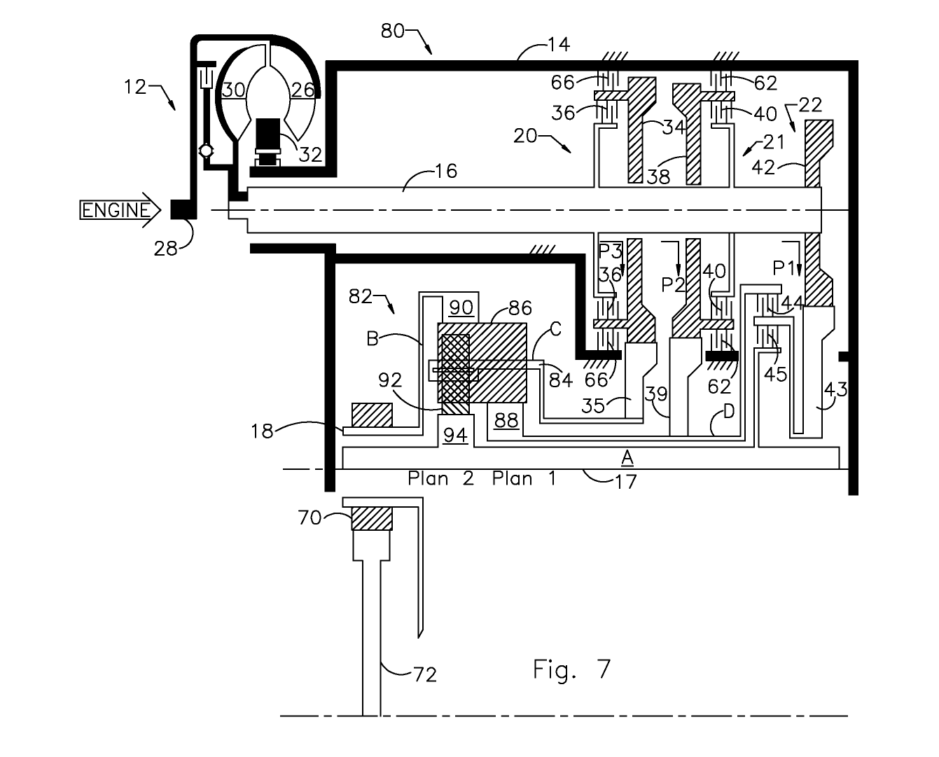

FIG. 7 illustrates transmission 80 configured such that brakes 62, 66 and clutches 36, 40 are concentric with input shaft 16, and pinions 34 and 38 are journalled on the input shaft 16, gear 35 is connected to carrier 84, and gear 39 is connected to sun gear 88.

In an alternate configuration (not shown) from that of FIG. 6 transmission 80 is configured such that brake 66 is concentric with shaft 17, as shown in FIG. 6, clutch 36 is concentric with input shaft 16, as shown in FIG. 7; pinion 34 is journalled on the input shaft 16; and gear 35 is driveably connected to carrier 84.

The control element application chart of FIG. 3 applies also to transmission 80. FIG. 3 shows that these ten operating modes or gears result from the concurrent application of two of the four clutches and two brakes. A change from each forward gear to the next higher or lower gear is produced by changing only one of the two currently engaged control elements. A change between the two reverse ranges is produced by changing only one of the two currently engaged control elements. Gear change operation of transaxle 80 is identical to that described with reference to transaxle 10.

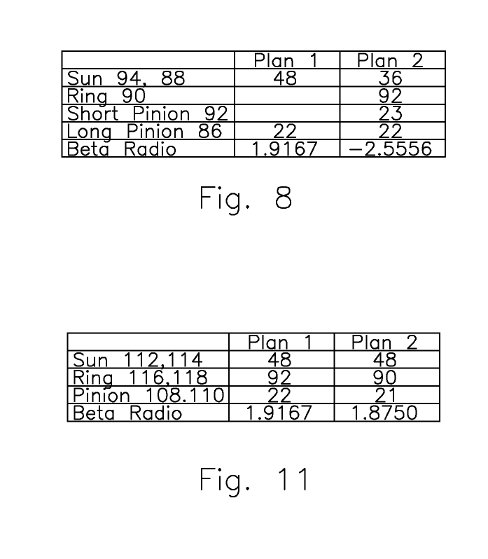

FIG. 4 shows the preferred number of gear teeth of the transfer gearsets 20, 21, 22. FIG. 8 shows the preferred number of gear teeth of the Ravigneaux planetary gear unit 82 and the corresponding beta ratios. The speeds of the output shaft 18, final drive pinion 70 and final drive gear 72 are identical to those of transmission 10, set forth above.

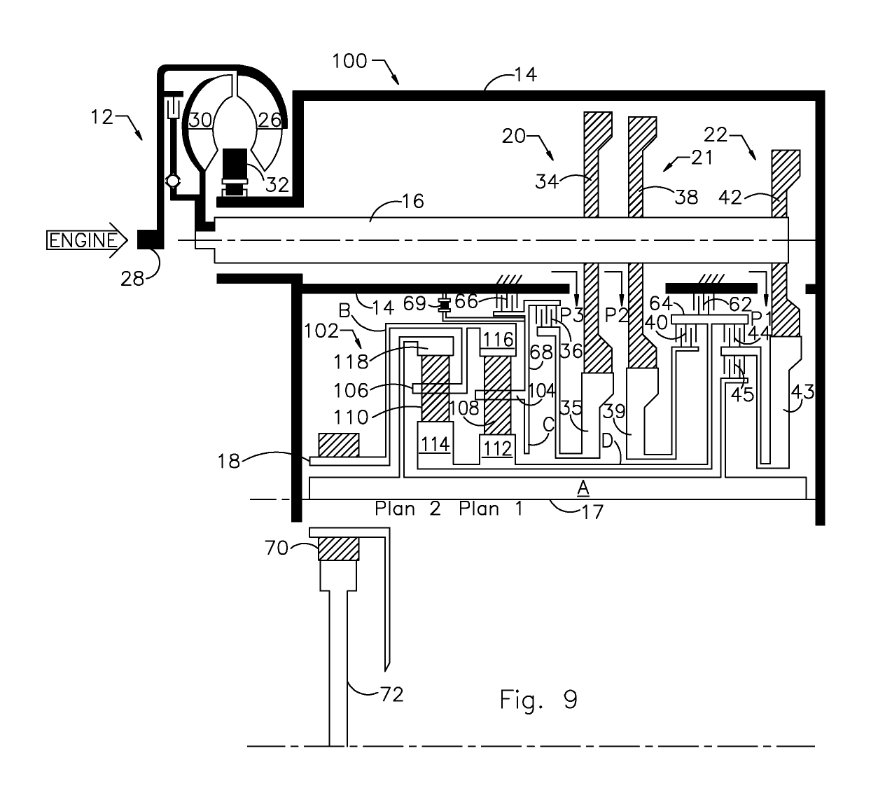

In FIG. 9, the transmission 100 includes the torque converter 12, casing 14, input shaft 16, second shaft 17, output shaft 18, high-speed transfer gearsets 20, 21, low-speed transfer gearset 22, and a double planetary gear unit 102, specifically a Simpson gear unit.

High-speed gearset 20 includes an input pinion 34 fixed to input shaft 16, and an output gear 35 meshing with the pinion and connected to control clutch 36. Gearset 20 forms a third path P3 having a high-speed ratio.

High-speed gearset 21 includes an input pinion 38 fixed to input shaft 16, and an output gear 39 connected to a control clutch 40. Gearset 21 forms a second power path P2 having a speed ratio approximately the same as the first speed ratio, preferably slightly lower in magnitude although it could be slightly higher.

Low-speed gearset 22 of includes an input pinion 42 fixed to input shaft 16, and an output gear 43 connected to a control clutches 44, 45. Gearset 22 forms a first power path P1 having a speed ratio lower in magnitude than either the second or third speed ratios. Each of the first, second, and third speed ratios are negative in the current embodiment.

Gear unit 102 includes a first and second planet carriers 104, 106 supporting first and second planet pinions 108, 110 and meshing with first and second sun gears 112, 114 and first and second ring gears 116, 118, respectively.

A first brake 62 alternately holds a component 64, common to clutches 40, 44, against rotation on casing 14 and releases component 64. A second brake 66 alternately holds carrier 104 and a component 68 of clutch 36 against rotation on casing 14 and releases those components.

Gear unit 102 includes a first rotating member A comprising ring gear 118; a second rotating member B comprising the planet carrier 106 fixed to the ring gear 116; a third rotating member C comprising planet carrier 104; and a fourth rotating member D comprising the mutually secured sun gears 112, 114. The first member A is associated with clutch 45; the second member B is secured to output shaft 18; the third member C is associated with clutch 36 and with brake 66; and the fourth member D is associated with clutches 40, 44 and with brake 62.

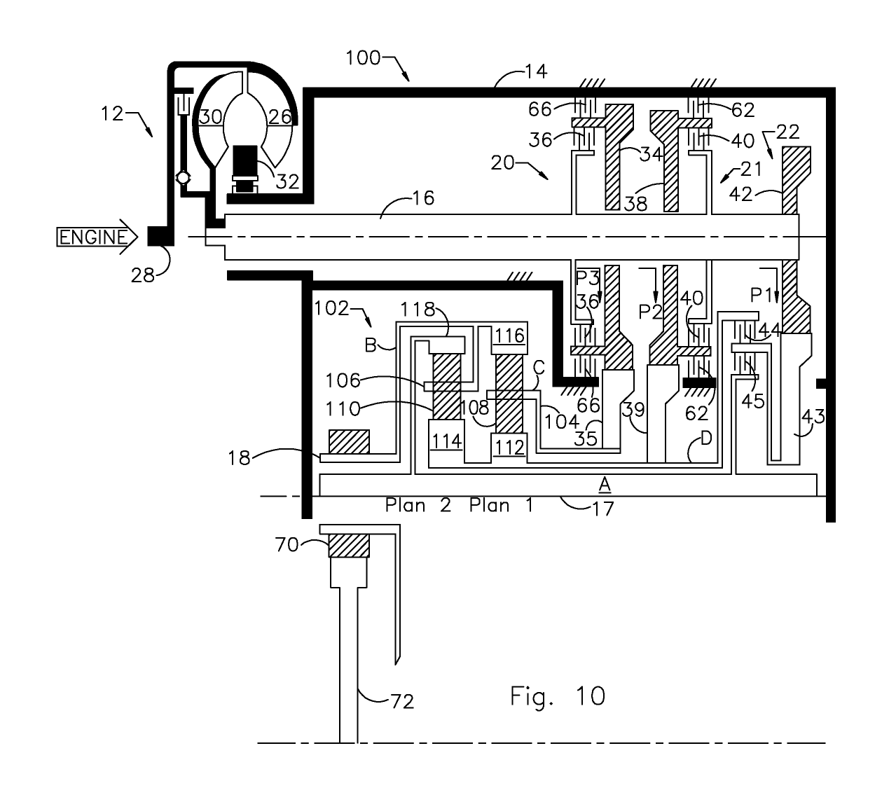

FIG. 10 illustrates transmission 100 configured such that brakes 62, 66 and clutches 36, 40 are concentric with input shaft 16, and pinions 34 and 38 are journalled on the input shaft 16, gear 35 is connected to carrier 104, and gear 39 is connected to sun gears 112, 114.

In an alternate configuration (not shown) from that of FIG. 9 transmission 100 is configured such that brake 66 is concentric with shaft 17, as shown in FIG. 9, clutch 36 is concentric with input shaft 16, as shown in FIG. 10; pinion 34 is journalled on the input shaft 16; and gear 35 is driveably connected to carrier 104.

The control element application chart of FIG. 3 applies also to transmission 100. FIG. 3 shows that these ten operating modes or gears result from the concurrent application of two of the four clutches and two brakes. A change from each forward gear to the next higher or lower gear is produced by changing only one of the two currently engaged control elements. A change between the two reverse ranges is produced by changing only one of the two currently engaged control elements. Gear change operation of transaxle 100 is identical to that described with reference to transaxle 10.

FIG. 4 shows the preferred number of gear teeth of the transfer gearsets 20, 21, 22. FIG. 11 shows the preferred number of gear teeth of the Simpson planetary gear unit 102 and the corresponding beta ratios. The speeds of the output shaft 18, final drive pinion 70 and final drive gear 72 are identical to those of transmission 10, set forth above.

In accordance with the provisions of the patent statutes, the preferred embodiment has been described. However, it should be noted that the alternate embodiments can be practiced otherwise than as specifically illustrated and described.

The invention claimed is:

1. A transmission, comprising:
an input and an output;
a first power path including first and second clutches;
a second power path including a third clutch;
a third power path including a fourth clutch;
a planetary gear unit including first, second, third and fourth members;
the first clutch coupling the first member to the input through the first power path, the second member secured to the output, the second clutch coupling the fourth member to the input through the first power path, the third clutch coupling the fourth member to the input through the second power path, the fourth clutch coupling the third member to the input through the third power path;
a first brake for holding the third member against rotation;
a second brake for holding the fourth member against rotation.

2. The transmission of claim 1, wherein the transmission produces up to eight forward gears and at least one reverse drive when two of said clutches and brakes are engaged and the other clutches and brakes are disengaged.

3. The transmission of claim 1, wherein
concurrent engagement of the first clutch and the first brake produces a first forward gear,
concurrent engagement of the first clutch and said second brake produces a second forward gear,
concurrent engagement of the first clutch and the second clutch produces a third forward gear,
concurrent engagement of the first clutch and the third clutch produces a fourth forward gear,
concurrent engagement of the first clutch and the fourth clutch produces a fifth forward gear,
concurrent engagement of the third clutch and the fourth clutch produces a sixth forward gear,
concurrent engagement of the second clutch and the fourth clutch produces a seventh forward gear,
concurrent engagement of the fourth clutch and the second brake produces an eighth forward gear.

4. The transmission of claim 1, wherein
concurrent engagement of the second clutch and the first brake produces a low-speed reverse drive; and
concurrent engagement of the third clutch and the first brake produces a higher-speed reverse drive.

5. The transmission of claim 1, wherein
the first power path has a first speed ratio;
the second power path has a second speed ratio greater in magnitude than the first speed ratio; and
the third power path has a third speed ratio substantially the same magnitude as the second speed ratio.

6. A transmission comprising:
an input and an output;
a first, second and third power paths connected to the input;
a double planetary gear unit including a first planet carrier carrying first planet pinions meshing with a first sun gear and a first ring gear, and a second planet carrier carrying second planet pinions meshing with a second sun gear and a second ring gear, the first and second sun gear being mutually secured, the second carrier being secured to the first ring gear and the output;
a first clutch coupling the sun gears to the input through the first power path;
a second clutch coupling the sun gears to the input through the second power path;
a third clutch coupling the input to second ring gear through the first power path;
a fourth clutch coupling the first carrier to the input through the third power path;
a first brake for holding the first carrier against rotation;
a second brake for holding the sun gears against rotation.

7. The transmission of claim 6, wherein:
the first power path comprises a first pinion secured to the input, and a first gear meshing with the first pinion and connected to the first and third clutches;
the second power path comprises a second pinion secured to the input, and a second gear meshing with the second pinion and connected to the second clutch; and
the third power path comprises a third pinion secured to the input, and a third gear meshing with the third pinion and connected to the fourth clutch.

8. The transmission of claim 6, wherein:
the first power path comprises a first pinion secured to the input, and a first gear meshing with the first pinion and connected to the first and third clutches;
the second power path comprises a second pinion journalled on the input and connected to the second clutch, and a second gear meshing with the second pinion and secured to the sun gears; and
the third power path comprises a third pinion journalled on the input and connected to the fourth clutch, and a third gear meshing with the third pinion and secured to the first carrier.

9. The transmission of claim 6, wherein
the first power path has a first speed ratio;
the second power path has a second speed ratio greater in magnitude than the first speed ratio; and
the third power path has a third speed ratio substantially the same magnitude as the second speed ratio.

10. A transmission comprising:
an input and an output;
a first, second and third power paths connected to the input;
a double planetary gearset including a first planet carrier carrying first planet pinions meshing with a first sun gear and a first ring gear, and a second planet carrier carrying second planet pinions meshing with a second sun gear and a second ring gear, the first carrier being connected to the second ring gear, the second carrier being secured to the first ring gear and the output;
a first clutch coupling the input to the second sun gear through the first power path;
a second clutch coupling the input to the first sun gear through the first power path;
a third clutch coupling the input to the first sun gear through the second power path;
a fourth clutch coupling the input to the second ring gear and first carrier through the third power path;
a first brake for holding the first carrier and second ring gear against rotation; and
a second brake holding the first sun gear against rotation.

11. The transmission of claim 10, wherein:
the first power path comprises a first pinion secured to the input, and a first gear meshing with the first pinion and connected to the first and second clutches; and
the second power path comprises a second pinion secured to the input, and a second gear meshing with the second pinion and connected to the third clutch;
the third power path comprises a third pinion secured to the input, and a third gear meshing with the third pinion and connected to the fourth clutch.

12. The transmission of claim 10, wherein:
the first power path comprises a first pinion secured to the input and a first gear meshing with the first pinion and connected to the first and second clutches;
the second power path comprises a second pinion journalled on the input and connected to the third clutch, and a second gear meshing with the second pinion and secured to the first sun gear; and
the third power path comprises a second pinion journalled on the input and connected to the fourth clutch, and a third gear meshing with the third pinion and secured to the first carrier and second ring gear.

13. The transmission of claim 10, wherein
the first power path has a first speed ratio;
the second power path has a second speed ratio greater in magnitude than the first speed ratio; and
the third power path has a third speed ratio substantially the same magnitude as the second speed ratio.

14. A transmission comprising:
an input and an output;
a first, second and third power paths connected to the input;
a double planetary gearset including a carrier supporting first planet pinions meshing with a first sun gear and a ring gear, and second planet pinions supported on the carrier and meshing with a second sun gear and the first planet pinions, the ring gear being secured to the output;
a first clutch coupling the input to the second sun gear through the first power path;
a second clutch coupling the input to the first sun gear through the first power path;
a third clutch coupling the input to first sun gear through the second power path;
a fourth clutch coupling the input to the carrier through the third power path;
a first brake for holding the carrier against rotation; and
a second brake for holding the first sun gear against rotation.

15. The transmission of claim 14, wherein:
the first power path comprises a first pinion secured to the input, and a first gear meshing with the first pinion and connected to the first and second clutches;
the second power path comprises a second pinion secured to the input, and a second gear meshing with the second pinion and connected to the third clutch; and
the third power path comprises a third pinion secured to the input, and a third gear meshing with the third pinion and connected to the fourth clutch.

16. The transmission of claim 14, wherein:
the first power path comprises a first pinion secured to the input, and a first gear meshing with the first pinion and connected to the first and second clutches;
the second power path comprises a second pinion journalled on the input and connected to the third clutch, and a second gear meshing with the second pinion and secured to the first sun gear; and
the third power path comprises a third pinion journalled on the input and connected to the fourth clutch, and a third gear meshing with the third pinion and secured to the carrier.

17. The transmission of claim 14, wherein:
the first power path has a first speed ratio;
the second power path has a second speed ratio greater in magnitude than the first speed ratio; and
the third power path has a third speed ratio substantially the same magnitude as the second speed ratio.

18. A transmission, comprising:
an input;
a compound planetary gear unit driving an output and including first, second, and third members;
clutches;
power paths, each power path connecting the input to one of the members through one of the clutches, a speed of said member differing from a speed of each of the other members;
a first brake for holding the third member against rotation;
a second brake for holding the second member against rotation.
